(19) United States
(12) Patent Application Publication
(10) Pub. No.: US 2003/0218881 A1
(43) Pub. Date: Nov. 27, 2003

(54) Lighting apparatus

(76) Inventors: Claus Hansen, Arhus C (DK); Jens Hansen, Hojbjerg (DK)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/393,646

(22) Filed: Mar. 21, 2003

Related U.S. Application Data
(60) Provisional application No. 60/366,312, filed on Mar. 21, 2002.

(51) Int. Cl. F21V 9/00

(52) U.S. Cl. 362/293; 362/283

(57) ABSTRACT

An apparatus for modulating the color of a light beam includes an inner color wheel provided with outwardly directed color filters around its circumference and an outer color wheel provided with inwardly directed color filters around its rim. The color wheels contra-rotate about a common axis and are positioned such that the color filters of a respective color wheel only partially cover the light beam. A lighting effect can be achieved which gives the impression of a complex pattern of moving colors within a beam of light, using components which are relatively simple and inexpensive.

### FIELD OF THE INVENTION

The present invention relates to an apparatus for modulating a light beam and, in particular, to an apparatus for varying the color of a projected light beam.

### BACKGROUND

Lighting fixtures (or “luminaires”) are used in theatres, nightclubs, concerts and the like to produce a wide variety of colorful visual effects. It is known for luminaires to include one or more moving color filters in order to produce a beam of light of continually changing color. Such an effect is commonly used in nightclubs and discos.

### SUMMARY OF THE INVENTION

In accordance with the present invention, there is provided a lighting apparatus for varying the color of a projected light beam. The apparatus includes a first filter device having a plurality of color filters arranged for movement in sequence across the light beam, and a second filter device having a plurality of color filters arranged for movement in sequence, across the light beam at the same time as the color filters of the first filter device. The first and second filter devices are arranged such that in operation there is relative movement between color filters of the first filter device and color filters of the second filter device. The color filters of at least one of the filter devices are arranged such that during movement of each filter across the light beam, the filter only partially covers the cross section of the light beam.

Thus, according to the invention, the color of a light beam is modulated by two sets of moving color filters, at least one of which only affects part of the cross-section of the light beam. In this way, using simple filter components, a light beam with a constantly changing two-color cross-section can be achieved. Furthermore, the relative movement of the two sets of filters results in a periodically changing relative distribution of colored regions in the cross-section. Therefore, a lighting effect is achieved to provide the impression of a complex pattern of moving colors within a beam of light, using components which are relatively simple, and therefore relatively inexpensive.

### BRIEF DESCRIPTION OF THE DRAWINGS

Embodiments of the invention will now be described, by way of example only, and with reference to the accompanying drawings, in which:

FIG. 1 is a plan view of the interior of a luminaire incorporating an a light modulating device of the invention;

FIG. 2 is a schematic view of the optical path in the luminaire of FIG. 1;

FIGS. 3 and 4 are a first and second angle perspective views of the interior of the luminaire of FIG. 1;

FIG. 5 shows the drive mechanism for the color wheels of the embodiment of FIG. 1; and

FIG. 6 is a first view of the color wheels illustrated in FIG. 1; and is a second view of the color wheels illustrated in FIG. 1.

### DETAILED DESCRIPTION

In the following, only those luminaire components which are relevant to the invention will be described in detail. Details related to other components will become apparent to persons of skill in the art in view of the following discussion.

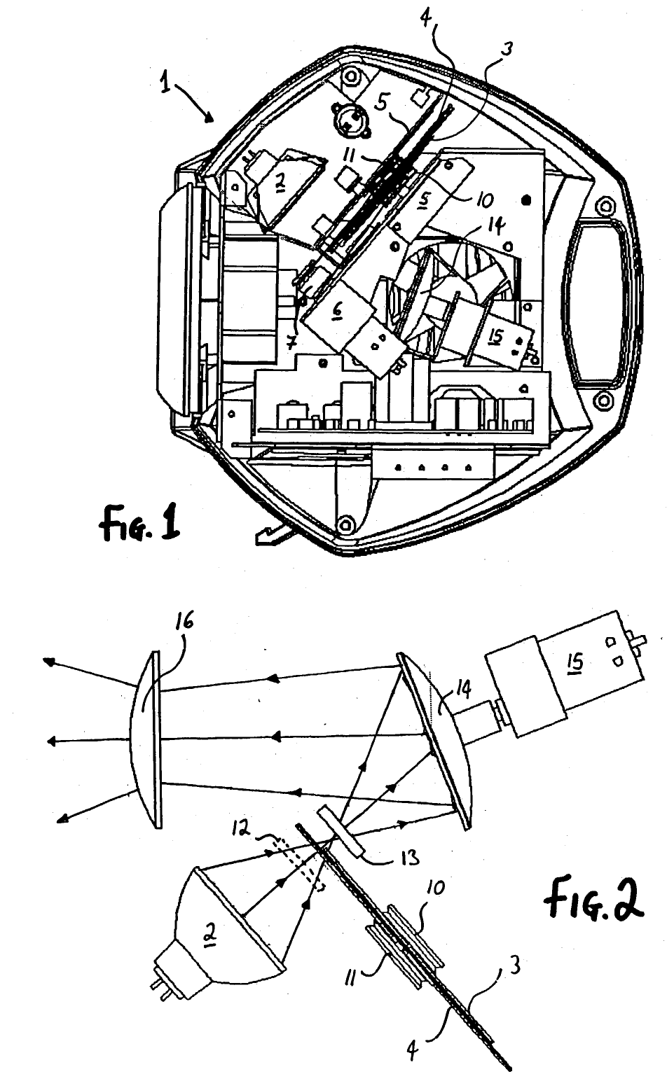

FIG. 1 illustrates the interior of a luminaire of the invention. The luminaire 1 includes a light source 2 in the form of a lamp directed at inner 3 and outer 4 color wheels. Both color wheels 3, 4, are mounted for rotation about a common axis on a chassis 5.

FIG. 2 illustrates the operation of an apparatus of the invention by reference to the light beam path in the luminaire of FIG. 1. The light beam emanates from a lamp 2. The light beam passing through the color filters 3, 4 (and the textured glass filter 13) is incident on a dished mirror 14. In one embodiment, the dished mirror 14 is made from a plurality of substantially flat mirrors that are mounted to a curved surface. The curved surface may be concave or convex. The curved surface may be, for example, a dish, a ball, or a cylinder. A well-known example of such a component is a mirror ball. In the illustrated embodiment, the concave inner surface of the dished mirror 14 is provided with an array of flat mirror tiles (see FIG. 4), each of which reflects the incident light in a slightly different direction. The dished mirror 14 splits the beam of light from the lamp 2 into a plurality of beams corresponding to the number of tiles. In another embodiment, a prism is used instead of the dished mirror 14 to split the modulated light beam.

When the light beam is split in this way, each beam of the plurality of beams will be colored according to its location in the cross-section of the modulated light beam. The resultant effect is of a plurality of differently-colored light beams, of continuously changing color. This arrangement is particularly effective when the light beams are projected through smoke. A particularly pleasing effect is further achieved when the optical component or mirror is arranged to rotate. Accordingly, in the illustrated embodiment, the dished mirror 14 is rotated by a second electric motor 15, which causes the pattern of beams of light produced by the mirror 14 to spin about a central beam.

A gobo 12 is optionally positioned between the lamp 2 and the color wheels 3, 4. The gobo 12 is intended to distract the observer from the movement of the color wheels while maintaining a high contrast in the projected beam from the luminaire 1. In another embodiment, a filter 13 of textured glass (commonly used in bathroom windows) is positioned on the opposite side of the color wheels 3, 4 from the lamp 2 so as to obscure the shape of the color wheels from the observer's view. As may be appreciated, the gobo 12 and textured glass filter 13 are not essential to the invention.

In some embodiments, the filter of textured glass 13, for example press-molded glass, is arranged to obscure the image of the color filters in the modulated light beam. Such a filter 13 is preferably positioned optically beyond the color filters. The filter 13 distracts the observer's attention from the impression of color filters moving across the image of the beam. In addition to textured glass, other suitable materials for the filter are frosted or unpolished glass, a many-faceted prism, and an annihilation lens, such as a Fresnel lens or a honeycomb lens. Finally, the modulated light beams from the dished mirror 14 are focused for projection by a lens 16.

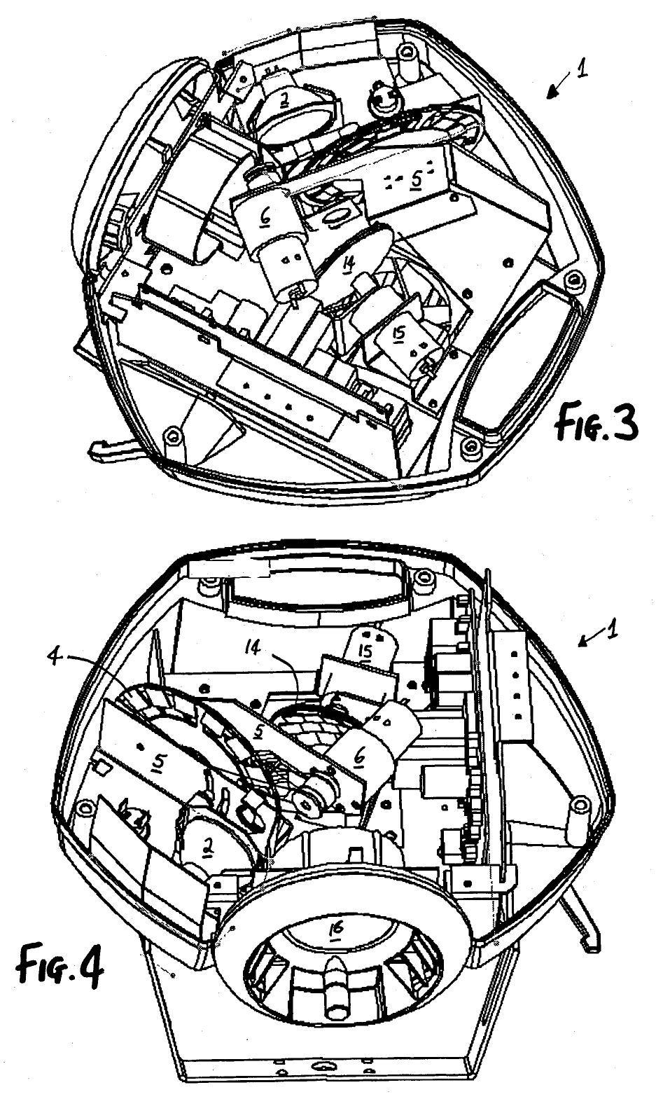

FIG. 3 illustrates a first angle view of the luminaire 1 of FIG. 1. In general, the apparatus is in the form of a component in a luminaire 1, or other lighting fixture. As discussed above, the luminaire includes a light source 2, for example a discharge or halogen lamp, arranged to produce the light beam. In some embodiments, the luminaire includes optical components, such as an elliptical reflector, arranged to direct light from the light source 2 as a defined beam of light. The luminaire may also include one or more lenses, prisms, shutters, and apertures arranged to affect the light beam emanating from the luminaire 1. Lenses may be arranged to image any of the optical components, such as the gobo 12 or textured glass filter 13 of FIG. 2. The luminaire may also provide additional optical effects, such as gobos, further color filters, prisms and mirrors.

FIG. 4 illustrates a second angle view of the luminaire of FIG. 1. As is shown, the apparatus includes a chassis 5, for example in the form of a pair of plates, to which one or both filter devices are mounted. An aperture (FIG. 5) in the chassis 5 provides, at least partially, a light path through the apparatus for the light beam.

FIG. 5 illustrates the chassis 5 and color wheels of the luminaire of FIGS. 1, 3, and 4. The color wheels 3, 4, are preferably mounted for rotation about respective spaced axis. The color wheels 3, 4, are mounted for rotation about a common axis. Such an arrangement provides a particularly compact construction, which is of advantage in minimizing the overall size of the luminaire 1 incorporating the apparatus.

Both color wheels 3, 4 are rotated by a first electric motor 6 via a drive pulley 7, respective drive belts 8, 9, and respective driven pulleys 10, 11. A drive belt 8 of the inner driven pulley 10 is crossed-over so that the inner color wheel 3 rotates in the opposite direction to the outer color wheel 4 when the drive pulley 7 is rotated by the first motor 6. In other embodiments, the coloring apparatus comprises a plurality of electric motors, provided for each color wheel 3, 4. The electric motor 6 is either directly coupled to the color wheels or is coupled to the color wheels by a transmission arrangement such as a gear train or drive belt. In the illustrated embodiment, the electric motor 6 is coupled to the color wheels 3, 4, by drive belts 8, 9.

In operation, as the inner and outer color wheels 3, 4 rotate in opposite directions, the color filters 17 of each color wheel 3, 4 cross the light beam, which is passing through an aperture 22 in the chassis 5. During rotation of the color wheels 3, 4, a portion of the cross-section of the light beam is colored by a color filter 17a from the outer color wheel 4 and a portion of the cross-section of the light beam is colored by a color filter 17b from the inner color wheel 3. As may be appreciated, an additional portion of the beam in the center of the field, where the color filters 17a, 17b overlap, is colored by both color filters 17a, 17b. The resultant effect includes constantly changing colors of the respective portions of the cross-section of the light beam. Colors of corresponding light beam cross-sections of the light beams, which are produced by the mirror 14, also change, because each tile of the mirror 14 produces an image of the modulated light beam directed in a slightly different direction. In this way, changing color beams are projected to a wide viewing area.

In the embodiment of FIG. 5, the color filters of the first and second color wheels 3, 4, are arranged to each only partially intersect the light beam. Preferably, as discussed above, there is at least some overlap between color filters of the respective color wheels 3, 4, so as to minimize the portion of the light beam that is not modulated by a color filter 17a, 17b. However, it is desirable to minimize the overlap region so as to reduce light loss and maintain adequate effect brightness.

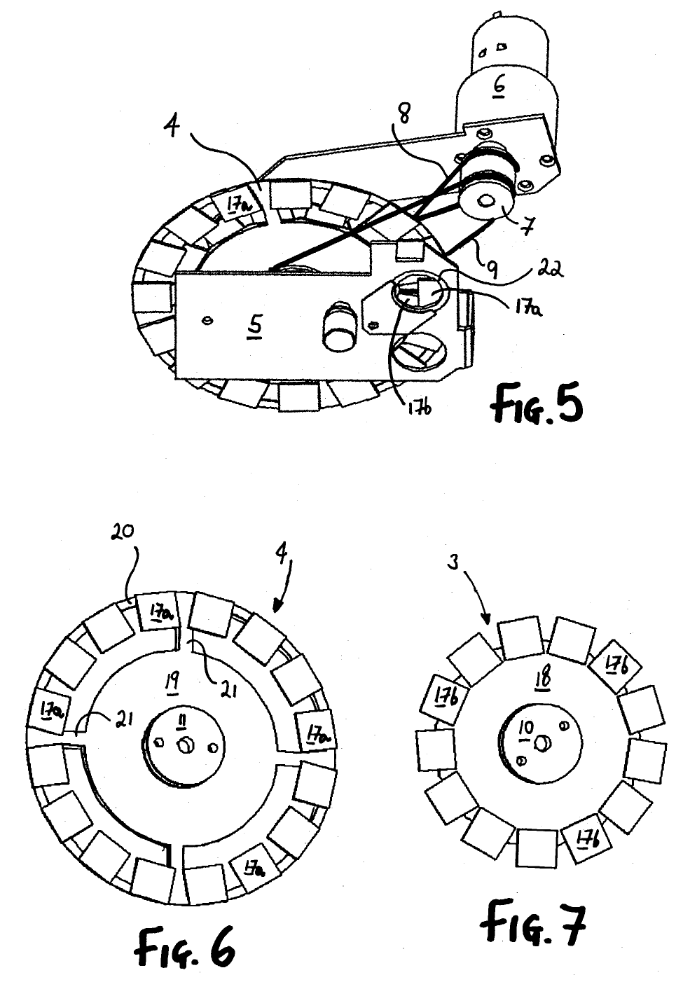

As shown most clearly in FIGS. 6 and 7, the inner and outer color wheels 3, 4 each comprise a plurality of dichromatic color filters 17 of different colors. The color filters 17 are in the form of discrete pieces of glass with a dichromatic coating. Each piece of glass is bonded to a corresponding color wheel 3, 4.

FIG. 6 illustrates the first, outer, color wheel 4 of the luminaire of FIG. 1. The first color wheel 4 is preferably formed from sheet metal, and has a larger diameter than the second, inner, color wheel 3. The outer color wheel 4 takes the form of a wheel with a central hub 19, a rim 20, and spoke members 21 connecting the rim to the hub. The color filters 17 are bonded around the inner edge of the rim 17.

FIG. 7 illustrates the second, inner, color wheel 3. The second wheel 3 is preferably formed from a disc 18 of sheet metal with the color filters 17 bonded around its outer edge similar to manner discussed with respect to the first wheel 4.

In one embodiment, the color filters 17a, 17b, are dichromatic filters. For example, the color filters 17a, 17b, may be discrete pieces of glass, or other transparent material, provided with a dichromatic coating. The use of discrete pieces simplifies the manufacture of the color wheels 3, 4. For example, the color wheels 3, 4, may be formed by adhesively bonding pieces of filter material to a substrate. In general, the plurality of color filters 17a, 17b, associated with each color wheel includes at least one color filter of a first color and a least one color filter of a second color which is different from the first color. Preferably, as many different filter colors as possible are provided in each color wheel 3, 4 to maximize color variance in the resultant visual effect. In one embodiment, adjacent filters 17a, 17b, of each color wheel 3, 4, are contiguous. However, in other embodiments, for ease of manufacture, adjacent color filters 17a, 17b, have gaps between them.

The substrate of each color wheel 3, 4 is preferably composed of either an opaque or a transparent material. Where the color wheel is of opaque material, a patterned aperture (or “gobo”) may be defined in the opaque material, where the color filters are provided, to enhance the optical effect created by the apparatus. Thus, in some embodiments, the color wheel includes a mask (or “gobo”) having openings defined therein to allow the light beam to include a predetermined pattern. In one embodiment, the openings are arranged simply to allow the maximum amount of light through the filters. In another embodiment, the openings are arranged to provide a desired aesthetic effect in the resultant light beam.

In another embodiment, the substrate for at least one color wheel is made of glass or other transparent material, to which the color filters are bonded. In one embodiment, the color wheels 3, 4 include a disc with a plurality of discrete color filters 17a, 17b, mounted about its circumference and extending radially outwardly there from. In another embodiment, the color wheels 3,4 include a rim connected to a hub by a plurality of spokes (or other radially extending members) and a plurality of discrete color filters 17a, 17b, mounted on the rim and extending radially inwardly there from. In one embodiment, an apparatus in accordance with the invention comprises one color wheel of each of these two types.

In one embodiment, the distribution and/or frequency of color filters 17a on the first color wheel 4 is different from that on the second color wheel 3. As may be appreciated, this frequency variance minimizes repetition of the same resultant light beam color combinations.

In another implementation, to facilitate relative movement between the respective color filters, 17a, 17b the first color wheel 4 is arranged to move color filters 17a across the light beam in a different direction, for example the opposite direction, to the direction of movement of the color filters 17b of the second color wheel 3. As may be appreciated, in one embodiment, one of the drive belts is crossed over in order to achieve contra-rotation of the color wheels 3, 4.

Alternatively, the first color wheel 4 is arranged to move the color filters 17a across the light beam at a different speed to the movement of the color filters 17b of the second color wheel 3. In this embodiment, the color wheels 3, 4, can be provided with different-sized drive pulleys 8, 9 in order for the color wheels to be driven at different speeds by the same motor.

In another embodiment, one of the color wheels 3, 4, is stationary, while the other color wheel moves through the light beam to provide continually changing light beam with only one rotating wheel.

Accordingly, the overall effect produced by the luminaire 1 is of a plurality of light beams, some having one color and others having another color, with the respective colors constantly changing. The plurality of light beams can be made to spin by correspondingly rotating the mirror 14 with the second electric motor 15. The color wheels 3, 4 required to produce this effect are relatively simple to manufacture and therefore relatively inexpensive.

In one embodiment, the apparatus of the invention further includes a controller (not shown), which is arranged to control the speed or direction of movement of at least one of the color wheels. In another embodiment, the controller is also arranged to control the speed or rotational direction of some or all of the above-mentioned optical component.

In summary, lighting apparatus for modulating the color of a light beam includes an inner color wheel provided with outwardly directed dichromatic color filters around its circumference and an outer color wheel provided with inwardly directed dichromatic color filters around its rim. The color wheels contra-rotate about a common axis and are positioned such that the color filters of a respective color wheel only partially cover the light beam. A resultant lighting effect provides the impression of a complex pattern of moving colors within a beam of light using components that are relatively simple and inexpensive.

The foregoing merely illustrates the principles of the present invention. Those skilled in the art will be able to devise various modifications, which although not explicitly described or shown herein, embody the principles of the invention and are thus within its spirit and scope.

1. An Apparatus for modulating a light beam, the apparatus comprising:
a first filter device comprising a plurality of color filters adapted to move in sequence across the light beam; and
a second filter device comprising a plurality of color filters, adapted to move in sequence across the light beam concurrently with the color filters of the first filter device, the first and second filter devices are adapted for relative movement between color filters of the first filter device and color filters of the second filter device, the color filters of at least one of said filter devices are adopted to only partially intersect the light beam during movement of each filter across the light beam.

2. The Apparatus of claim 1, wherein the color filters of both filter devices are arranged such that during movement of each filter across the light beam, the respective filter only partially covers the light beam.

3. The Apparatus of claim 1, wherein the color filters are discrete, dichromatic filters.

4. The Apparatus of claim 1, wherein each filter device comprises a color wheel.

5. The Apparatus of claim 4, wherein at least one color wheel comprises a disc with a plurality of discrete color filters mounted about its circumference and extending radially outwardly therefrom.

6. The Apparatus of claim 5, wherein at least one color wheel comprises a rim connected to a hub by a plurality of spokes and a plurality of discrete color filters mounted on the rim and extending radially inwardly therefrom.

7. The Apparatus of claim 6, wherein the color wheels are mounted for rotation about a common axis.

8. The Apparatus of claim 1, wherein the first filter device is arranged to move color filters across the light beam in the opposite direction to the direction of movement of the color filters of the second filter device.

9. The Apparatus of claim 8, wherein the filter devices are arranged to contra-rotate.

10. The Apparatus of claim 1, wherein the first filter device is arranged to move the color filters across the light beam at a different speed to the movement of the color filters of the second filter device.

11. The Apparatus of claim 1, further comprising an electric motor arranged to drive both filter devices.

12. The Apparatus of claim 1, further comprising an optical component arranged to split the light beam, after modulation by the color filters, into a plurality of light beams.

13. The Apparatus of claim 12, wherein the optical component is arranged to rotate.

14. The Apparatus of claim 1, further comprising a luminaire comprising a light source arranged to produce a beam of light, which the apparatus of claim 1 modulates.

15. A method for color modulating a light beam in a light projecting apparatus, the light beam having a cross section, the method comprising:
interposing a first color filter across at least a first portion of the beam cross section, the first color filter is one of a first plurality of color filters arranged in sequence, the first plurality of color filters adapted to move in sequence across said first portion of the beam cross section; and
sequentially interposing a second color filter, of a second plurality of color filters arranged in sequence, across at least a second portion of the beam cross section, said second portion of the beam cross section including portions outside of said first portion of the beam cross section.

16. The method of claim 15, further comprising sequentially interposing each of said first color filters of said first plurality of color filters across at least said first portion of the beam cross section concurrently with the second color filters of said second plurality of color filters.

17. The method of claim 16, wherein said sequentially interposing each of said first color filters of said first plurality of color filters is at a first rate and said sequentially interposing each of said second color filters of said second plurality of color filters is at a second rate, and further wherein the first rate is different from the second rate.

18. The method of claim 15, wherein at least the first color filters of said first plurality of color filters are adopted to only partially intersect the light beam cross section.

19. The method of claim 15, wherein the first color filters of said first plurality of color filters and the second color filters of said second plurality of color filters both intersect a common portion of the light beam cross section.
